(19) United States
(12) Patent Application Publication
(10) Pub. No.: US 2024/0127975 A1
(43) Pub. Date: Apr. 18, 2024

(54) SERIAL HIGH-TEMPERATURE GAS-COOLED REACTOR NUCLEAR SYSTEMS AND OPERATING METHODS THEREOF

(71) Applicant: Huaneng Nuclear Energy Technology Research Institute Co. Ltd., Shanghai (CN)

(72) Inventors: Tao ZHANG, Shanghai (CN); Xingtian ZHANG, Shanghai (CN); Huaquan LV, Shanghai (CN); Wenbin WEI, Shanghai (CN); Yong LUO, Shanghai (CN); Jilan ZHANG, Shanghai (CN); Miaomiao WANG, Shanghai (CN)

(21) Appl. No.: 18/484,494

(22) Filed: Oct. 11, 2023

(30) Foreign Application Priority Data
Oct. 11, 2022 (CN) 202211239715.3

(51) Int. Cl. G21C 15/253; G21C 1/07; G21C 19/20

(52) U.S. Cl. CPC G21C 15/253; G21C 1/07; G21C 19/202

(57) ABSTRACT

The invention discloses a serial high-temperature gas-cooled reactor nuclear energy system and an operating method thereof. The serial high-temperature gas-cooled reactor nuclear energy system includes a plurality of high-temperature gas-cooled reactors and a serial gas-cooled reactor. The high-temperature gas-cooled reactor includes a first reactor pressure vessel comprising a first reaction chamber for accommodating the first fuel element; a second reactor pressure vessel comprising a second reaction chamber interconnected with the first reaction chamber, allowing the first spent fuel in the first reaction chamber to enter the second reaction chamber. The system of the present invention allows the spent fuel discharged from the high-temperature gas-cooled reactor to be directly reused as fuel for the serial gas-cooled reactor, thereby improving the utilization rate of nuclear fuel and reducing the cost of gas-cooled reactors, which is conducive to the promotion of industrialized application of high-temperature gas-cooled reactors.

### CROSS-REFERENCE TO RELATED APPLICATIONS

The present application claims priority from a Chinese patent application serial number 202211239715.3 filed Oct. 11, 2022, and the disclosures of which are incorporated by reference in their entireties.

### FIELD OF THE INVENTION

The present invention relates to nuclear reactors, more specifically to a serial high-temperature gas-cooled reactor nuclear energy system and its operation method.

### BACKGROUND

High-temperature gas-cooled reactors are fourth-generation advanced nuclear reactors that use coated particles and use graphite as moderator. The reactor core outlet temperature is 750° C.˜1000° C., or even higher. High-temperature gas-cooled reactor is a green energy transition technology that can be widely used in high-temperature nuclear hydrogen production, coal-fired unit replacement, cogeneration, helium turbine direct cycle power generation, supercritical carbon dioxide unit power generation, petrochemical industry, coal chemical industry, heavy oil thermal recovery, oil shale refining, seawater desalination and urban residential district heating and other fields.

Compared with commercial large-scale pressurized water reactors, high-temperature gas-cooled reactors have the advantages of inherent safety, small modularity, simple structure, and can provide high-quality heat sources and high-parameter steam sources. However, compared with commercial large-scale pressurized water reactors, high-temperature gas-cooled reactors also have disadvantages such as smaller thermal power and high operating fuel costs, which restricts the industrial promotion and application of high-temperature gas-cooled reactors.

The present invention aims to solve one of the technical problems in the related art, at least to a certain extent.

### SUMMARY OF THE INVENTION

In view of the above, a serial high-temperature gas-cooled reactor nuclear energy system to increase the thermal power of the gas-cooled reactor nuclear energy system and reduce the fuel cost of the gas-cooled reactor nuclear energy system is provided herewith.

In a first aspect of the invention, a serial high-temperature gas-cooled reactor nuclear energy system is provided, which includes a plurality of high-temperature gas-cooled reactors and a serial gas-cooled reactor. The high-temperature gas-cooled reactor includes a first reactor pressure vessel, and the first reactor pressure vessel has a first reaction chamber used to accommodate a first fuel element; the serial gas-cooled reactor includes a second reactor pressure vessel, the second reactor pressure vessel has a second reaction chamber, wherein the first reaction chambers of the plurality of first high-temperature gas-cooled reactors are all connected to the second reaction chamber, so that the first spent fuel in the first reaction chambers enter the second reaction chambers.

In some embodiments, the serial high-temperature gas-cooled reactor nuclear energy system further includes a first fuel loading/unloading system capable of transferring the first spent fuel in the first reaction chamber to inside the second reaction chamber.

In some embodiments, the high-temperature gas-cooled reactor is a pebble-bed high-temperature gas-cooled reactor, and the first fuel element is a spherical fuel element; the first reactor pressure vessel also has a first fuel inlet and a first fuel outlet connected to the first reaction chamber; the second reactor pressure vessel also has a second fuel inlet and a second fuel outlet connected to the second reaction chamber; the first fuel outlet is connected to the second fuel inlet through the first fuel loading/unloading system to transfer the first spent fuel in the first reaction chamber to the second reaction chamber.

In some embodiments, the first fuel loading/unloading system includes a first unloading pipe and a first unloading device. One end of the first unloading pipe connects to the first fuel outlet through the first unloading device to unload the first spent fuel in the first reaction chamber, and the other end of the first unloading pipe is connected to the second fuel inlet to unload the first spent fuel from the first reaction chamber into the second reaction chamber.

In some embodiments, the second fuel inlet is positioned lower than the first fuel outlet.

In some embodiments, the high-temperature gas-cooled reactor is a prismatic high-temperature gas-cooled reactor, and the first fuel element is a prismatic fuel element; the first reactor pressure vessel includes a first inlet and outlet and a top cover of the first reactor pressure vessel for confining the first reaction chamber, the second inlet and outlet is connected to the first reaction chamber, and the second reactor pressure vessel includes a second inlet and outlet and a top cover of the second reactor pressure vessel. The second inlet and outlet are connected with the second reaction chamber. The first spent fuel is unloaded through the first inlet and outlet from the first reaction chamber, and loaded into the second reaction chamber through the second inlet and outlet.

In some embodiments, the second inlet and outlet are positioned on the same level with or lower than the first inlet and outlet.

In some embodiments, the serial high-temperature gas-cooled reactor nuclear energy system further includes a spent fuel storage tank, the spent fuel storage tank has a storage chamber, and the storage chamber is connected to the second reaction chamber so that the second spent fuel in the second reaction chamber enters the storage chamber.

In some embodiments, the serial high temperature gas-cooled reactor nuclear energy system further includes a second fuel loading/unloading system, the second fuel loading/unloading system is used to transfer the second spent fuel in the second reaction chamber into the storage chamber.

In some embodiments, the high-temperature gas-cooled reactor is a pebble-bed high-temperature gas-cooled reactor, and the first fuel element is a spherical fuel element; the first reactor pressure vessel also has a first fuel inlet and a first fuel outlet connected to the first reaction chamber., the second reactor pressure vessel also has a second fuel inlet and a second fuel outlet connected to the second reaction chamber, and the spent fuel storage tank has a spent fuel inlet connected to the storage chamber; wherein the second fuel inlet is connected to the first fuel outlet, and the second fuel inlet is connected to the spent fuel inlet through the second fuel loading/unloading system.

In some embodiments, the second fuel loading/unloading system includes a second unloading pipe and a second unloading device. One end of the second unloading pipe passes through the second unloading device and connects to the second fuel outlet to unload the second spent fuel in the second reaction chamber, and the other end of the second unloading pipe is connected to the spent fuel inlet to unload the second spent fuel from the second reaction chamber into the storage chamber.

In some embodiments, the spent fuel inlet is positioned lower than the second fuel outlet.

In some embodiments, the second fuel loading/unloading system further includes a spent fuel circulation pipe. One end of the spent fuel circulation pipe is connected to the second fuel outlet through the second unloading device. The other end of the spent fuel circulation pipe is connected to the second fuel inlet so that the first spent fuel circulates in the second reaction chamber.

In some embodiments, the high-temperature gas-cooled reactor is a prismatic high-temperature gas-cooled reactor, and the first fuel element is a prismatic fuel element; the first reactor pressure vessel includes a first inlet and outlet and a top cover of the first reactor pressure vessel for confining the first reaction chamber; the second inlet and outlet are connected to the first reaction chamber, and the second reactor pressure vessel includes a second inlet and outlet and a second reactor pressure vessel top cover to confine the second reaction chamber, the second inlet and outlet are connected to the second reaction chamber, and the spent fuel storage tank has a spent fuel inlet connected to the storage chamber; wherein the second fuel loading/unloading system is used to unload the second spent fuel in the second reaction chamber through the second inlet and outlet, and load it into the storage chamber through the spent fuel inlet.

In some embodiments, the spent fuel inlet is positioned on the same level or lower than the second inlet and outlet.

In some embodiments, the number of high-temperature gas-cooled reactors is 2 to 3.

In some embodiments, the core outlet temperature of the high-temperature gas-cooled reactor is 750° C. to 1000° C.; the core outlet temperature of the serial gas-cooled reactor is 350° C. to 450° C.

In some embodiments, the cooling gas pressure of the high-temperature gas-cooled reactor is 3.0 MPa to 7.0 MPa; the cooling gas pressure of the serial gas-cooled reactor is 2.0 MPa to 4.5 MPa.

In some embodiments, the second reactor pressure vessel is a metal pressure vessel or a concrete pressure vessel.

In some embodiments, the interior of the concrete pressure vessel includes a metal lining.

In some embodiments, the second reactor pressure vessel further includes a cylindrical graphite reflective layer and a thermal insulation layer. The cylindrical graphite reflective layer is located in the second reaction chamber; the thermal insulation layer is located between the cylindrical graphite reflective layer and the second reactor pressure vessel.

In some embodiments, a columnar graphite reflective layer for inserting reactor control rods is provided in the middle of the cylindrical graphite reflective layer, and an annular space is defined between the columnar graphite reflective layer and the cylindrical graphite reflective layer, which is used to accommodate the first spent fuel.

In some embodiments, the serial high-temperature gas-cooled reactor nuclear energy system further includes a plurality of first steam generators, and each of the first steam generators correspond to a high-temperature gas-cooled reactor one by one. Each of the first steam generators is connected to the corresponding high-temperature gas-cooled reactor.

In some embodiments, the serial high-temperature gas-cooled reactor nuclear energy system further includes a second steam generator connected to the serial gas-cooled reactor; or an intermediate heat exchanger, which is connected to the serial gas-cooled reactor.

In some embodiments, the fuel core of the first fuel element is at least one of UO₂, UC₂, ThO₂, ThC₂, (U, Th)O₂ and (U, Th)C₂.

An operation method of the serial high-temperature gas-cooled reactor nuclear energy system described in any of the above embodiments is also provided herewith, which includes the following steps:
adding first fuel elements into the first reaction chambers of a plurality of the high-temperature gas-cooled reactors and operating the high-temperature gas-cooled reactors to initiate nuclear reactions of the first fuel elements and obtain the first spent fuel; and
adding all or part of the first spent fuel produced by multiple high-temperature gas-cooled reactors into the second reaction chamber of the serial gas-cooled reactor (2) and operating the serial gas-cooled reactor to allow the first spent fuel to undergo nuclear reaction.

In some embodiments, when the high-temperature gas-cooled reactor does not produce the first spent fuel, natural uranium is added as a second fuel element into the second reaction chamber of the serial gas-cooled reactor, and the serial gas-cooled reactor is operated so that the second fuel element undergoes nuclear reaction.

When the serial high-temperature gas-cooled reactor nuclear energy system of the embodiment of the present invention is under operation, the first fuel element is added into the first reaction chamber of the high-temperature gas-cooled reactor, and the high-temperature gas-cooled reactor is operated, that is, the first fuel element is in the first reaction chamber A nuclear reaction occurs in the first reaction chamber; when the first fuel element reaches the discharge burnup in the first reaction chamber, it becomes the first spent fuel and is unloaded from the first reaction chamber. The unloaded first spent fuel has good mechanical integrity, high percentage content of fissile materials and large burnup margin, so it can be used as fuel for serial gas-cooled reactors. Specifically, all or part of the first spent fuel produced by the plurality of high-temperature gas-cooled reactors is added into the second reaction chamber of the serial gas-cooled reactor, and the serial gas-cooled reactor is operated. That is, the first spent fuel is used as the fuel of the serial gas-cooled reactor. The fuel of the reactor undergoes nuclear reaction in the second reaction chamber; when the first spent fuel reaches the discharge burnup in the second reaction chamber, it becomes the second spent fuel and is unloaded from the second reaction chamber. As such, the spent fuel unloaded from the high-temperature gas-cooled reactor, i.e. the first spent fuel, can be directly used as fuel for the serial gas-cooled reactor, thereby improving the utilization rate of nuclear fuel and reducing the fuel cost of the gas-cooled reactor nuclear energy system. In addition, when high-temperature gas-cooled reactors and serial gas-cooled reactors operate at the same time, the thermal power of the gas-cooled reactor nuclear energy system can also be improved, which is conducive to the promotion of industrialized application of high-temperature gas-cooled reactors.

### BRIEF DESCRIPTION OF THE DRAWINGS

FIG. 1 is a schematic structural diagram of a serial high-temperature gas-cooled reactor nuclear energy system according to an embodiment of the present invention.

FIG. 2 a schematic structural diagram of the serial gas-cooled reactor in FIG. 1.

### REFERENCE NUMBERS

serial high-temperature gas-cooled reactor nuclear energy system 100;

high-temperature gas-cooled reactor 1; first reactor pressure vessel 101; first fuel inlet 1011; first fuel outlet 1012; first outer tube;

serial gas-cooled reactor 2; second reactor pressure vessel 201; second fuel inlet 2011; second fuel outlet 2012; second outer tube; second inner tube 2014; cylindrical graphite reflective layer 202; metal lining 203; thermal insulation layer 204; columnar graphite reflection layer 205; reactor control rod 206; second cooling gas channel 207; second reactor pressure vessel top cover 207;

first unloading pipe 3;

first unloading device 4;

fuel circulation system 5; fuel circulation pipe 501;

spent fuel storage tank 6; storage chamber 601; spent fuel inlet 6011;

second unloading pipe 7;

second unloading device 8;

first steam generator 9; first liquid inlet 901; first steam outlet 902; first main helium blower 903;

second steam generator 10; second liquid inlet 1001; second steam outlet 1002; second main helium blower 1003.

### DETAILED DESCRIPTION

Embodiments of the invention are described in detail below, examples of which are illustrated in the accompanying drawings. The embodiments described below with reference to the drawings are exemplary and are intended to explain the present invention and are not to be construed as limiting the present invention.

In the existing technology, high-temperature gas-cooled reactors are divided into pebble-bed high-temperature gas-cooled reactors and prismatic high-temperature gas-cooled reactors according to the shape of the reactor core. Pebble-bed high-temperature gas-cooled reactors use spherical fuel elements that are refueled without stopping; prismatic high-temperature gas-cooled reactors use prismatic fuel elements that are refueled with stops, such as hexagonal first fuel elements.

The results of the irradiation test in the reactor show that, for the high-temperature gas-cooled reactor which uses a TRISO (tristructural isotropic) structure to coat the fuel particles of the fuel element, the radiation damage rate of the coated fuel particles is less than or equal to 2×10⁻⁴. The fuel consumption can reach more than 150 GWd/tU. Since high-temperature gas-cooled reactors are subject to critical conditions, the average discharge burnup of fuel elements in high-temperature gas-cooled reactors (the depth of burnup of fuel elements that are unloaded from the nuclear power plant during refueling and are no longer used in the reactor average) is only 80 GWd/tU to 107 GWd/tU, with a margin of at least 43 GWd/tU.

In addition, the study found that the fissile material ²³⁵U contained in the spent fuel discharged from the high-temperature gas-cooled reactor accounts for more than 1% of the total uranium, which is higher than the ²³⁵U enrichment in natural uranium (0.712%). The spent fuel also contains plutonium. The share of medium-fission plutonium (²³⁹Pu and ²⁴¹Pu) is about 50% or more.

To sum up, the spent fuel of high-temperature gas-cooled reactors has the following characteristics:
(1) The mechanical integrity of spent fuel is good;
(2) The percentage content of fissile materials in spent fuel is relatively high;
(3) There is a large margin for spent fuel burnup.

The above characteristics of the spent fuel of high-temperature gas-cooled reactors create conditions for the secondary utilization of spent fuel of high-temperature gas-cooled reactors.

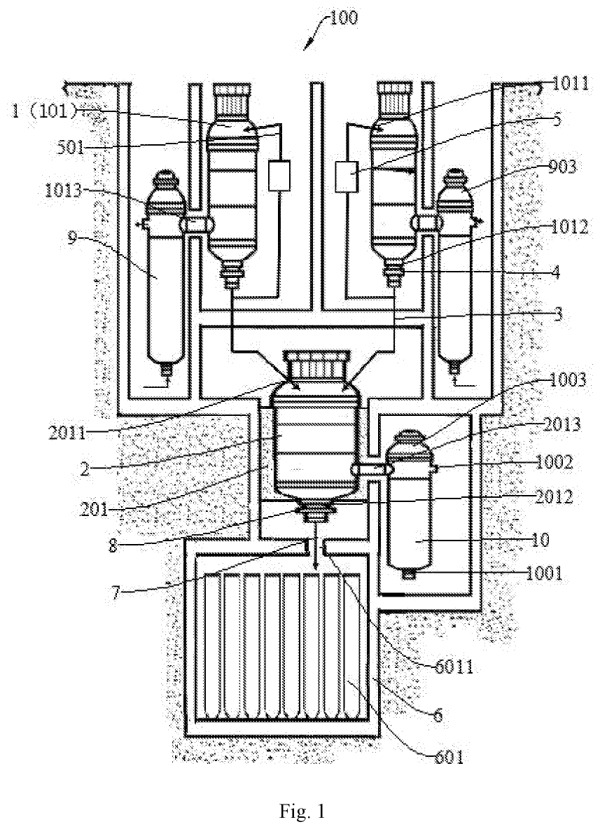

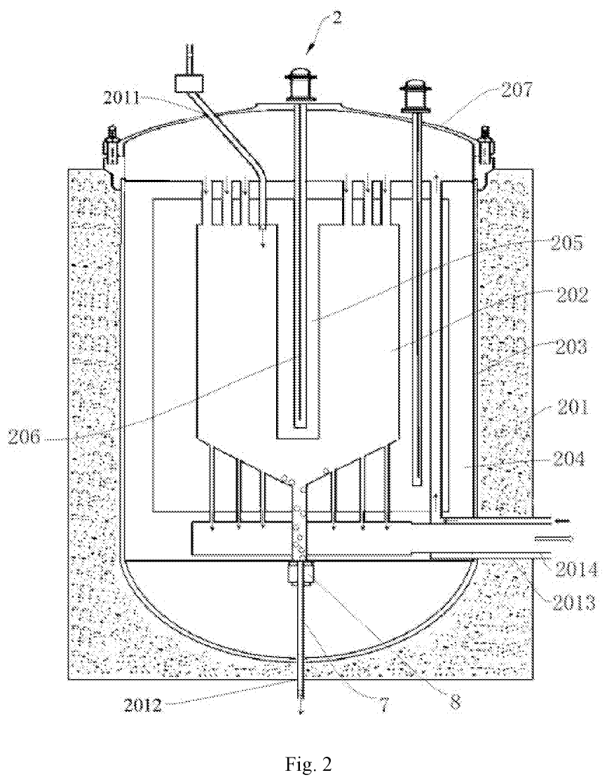

As shown in FIGS. 1 and 2, the serial high-temperature gas-cooled reactor nuclear energy system 100 according to the embodiment of the present invention includes multiple high-temperature gas-cooled reactors 1 and serial gas-cooled reactors 2. The high-temperature gas-cooled reactor 1 includes a first reactor pressure vessel 101, a first reactor pressure vessel 101 has a first reaction chamber for accommodating a first fuel element. The serial gas-cooled reactor 2 includes a second reactor pressure vessel 201. The second reactor pressure vessel 201 has a second reaction chamber. The first reaction chambers of the multiple high-temperature gas-cooled reactors 1 are all connected to the second reaction chamber, so that the first spent fuel in the first reaction chamber enters the second reaction chamber.

Among them, the serial high-temperature gas-cooled reactor nuclear energy system refers to: the physical positions and fuel cycles of at least two gas-cooled reactors in the high-temperature gas-cooled reactor nuclear energy system are connected in series, that is, at least one gas-cooled reactor in the high-temperature gas-cooled reactor nuclear energy system A gas-cooled reactor located upstream of another gas-cooled reactor and located downstream can use spent fuel from the gas-cooled reactor located upstream. Serial gas-cooled reactor 2 refers to a helium-cooled reactor with a larger core size than a small-capacity modular high-temperature gas-cooled reactor, the fuel element of which could be the spent fuel of the small-capacity modular high-temperature gas-cooled reactor with good mechanical integrity. The first spent fuel can be understood as: the first fuel element that reaches unloading fuel consumption in the high-temperature gas-cooled reactor 1.

When the serial high-temperature gas-cooled reactor nuclear energy system 100 of the embodiment of the present invention is working, the first fuel element is added into the first reaction chamber of the high-temperature gas-cooled reactor 1, and the high-temperature gas-cooled reactor 1 is operated, that is, the first fuel element is in the first reaction chamber of the high-temperature gas-cooled reactor 1. A nuclear reaction occurs in a reaction chamber; when the first fuel element reaches the unloading fuel consumption in the first reaction chamber, it becomes the first spent fuel and is discharged from the first reaction chamber. The discharged first spent fuel can be used as fuel for the serial gas-cooled reactor 2 due to its good mechanical integrity, high percentage content of fissile materials and large burn-up margin. Specifically, all or part of the first spent fuel produced by multiple high-temperature gas-cooled reactors 1 is added into the second reaction chamber of the serial gas-cooled reactor 2, and the serial gas-cooled reactor 2 is operated, that is, the first spent fuel is used as the serial gas-cooled reactor. The fuel in the gas-cooled reactor 2 undergoes a nuclear reaction in the second reaction chamber; when the first spent fuel reaches the discharge burnup in the second reaction chamber, it becomes the second spent fuel and is discharged from the second reaction chamber.

As a result, the spent fuel discharged from the high-temperature gas-cooled reactor 1, that is, the first spent fuel, can be directly used as fuel for the serial gas-cooled reactor 2, thereby improving the utilization rate of the first fuel element and reducing the cost of the serial gas-cooled reactor. The fuel cost of the high-temperature gas-cooled reactor nuclear energy system 100. In addition, when the high-temperature gas-cooled reactor 1 and the serial gas-cooled reactor 2 operate at the same time, the thermal power of the gas-cooled reactor nuclear energy system can also be increased, which is conducive to the promotion of the industrialized application of high-temperature gas-cooled reactors.

It can be understood that when the first spent fuel is used as the fuel of the serial gas-cooled reactor 2, the critical conditions of the serial gas-cooled reactor 2 need to be determined based on the condition of the first spent fuel, that is, the serial gas-cooled reactor 2 reaches the critical condition. status conditions. Among them, the critical conditions of the reactor include the critical volume of the reactor, the composition of the reactor materials (the enrichment of fissile materials in the fuel and the neutron moderator) and the loading capacity.

The critical conditions of the reactor can be summarized into two types of problems. The first type of problem is to determine its critical size given the material composition of the reactor. The second type of problem is to determine the reactor material composition given the shape and size of the reactor. The determination of the critical conditions of the serial gas-cooled reactor 2 in this application belongs to the first type of problem. Specifically, the critical conditions are as follows:

Critical equation:

$${k}_{eff} = \frac{{k}_{∞}}{1 + {L}^{2} {B}^{2}} = 1$$

Spatial distribution of neutron flux in a steady-state reactor satisfies the wave equation:

∇²φ(r)+B²φ(r)=0

where K_{eff} is the effective value-added coefficient; K_{∞} is the infinite medium value-added coefficient; L² is the neutron diffusion length; B² is the eigenvalue of the wave equation; φ(r) is the neutron flux density. k_{∞} and L² only depend on the material properties of the reactor core components. Therefore, for a serial gas-cooled reactor 2 with a certain reactor material composition, there is a certain B 2 that satisfies the critical equation.

It can be seen from the above critical conditions that using the first spent fuel as the fuel of the serial gas-cooled reactor 2 can operate at critical and continuous power. Moreover, the critical size of the serial gas-cooled reactor 2 is larger than the critical size of the high-temperature gas-cooled reactor 1. Therefore, a serial gas-cooled reactor 2 needs to be connected to two or more high-temperature gas-cooled reactors 1, so that a serial gas-cooled reactor 2 can use the first spent fuel discharged from more than two high-temperature gas-cooled reactors 1 as fuel.

Optionally, the number of high-temperature gas-cooled reactors 1 is 2 to 3.

For example, as shown in FIG. 1, the number of high-temperature gas-cooled reactors 1 is two, and the first reaction chambers of the two high-temperature gas-cooled reactors 1 are connected to the same serial gas-cooled reactor 2. The first spent fuel produced in the two high-temperature gas-cooled reactors 1 is added to the second reaction chamber of the serial gas-cooled reactor 2 and used as fuel for the serial gas-cooled reactor 2.

By setting the number of high-temperature gas-cooled reactors 1 as 2 to 3, the size of the serial gas-cooled reactors 2 is not too large, which facilitates the control of the serial gas-cooled reactors 2 and thus facilitates control of the serial high-temperature gas-cooled reactor nuclear system 100.

Optionally, when the serial high-temperature gas-cooled reactor nuclear energy system 100 is first operated, the high-temperature gas-cooled reactor 1 can be operated first, and when the first spent fuel produced by the high-temperature gas-cooled reactor 1 is enough to be used as fuel for the serial gas-cooled reactor 2, and then add the first spent fuel into the serial gas-cooled reactor 2 to make the serial gas-cooled reactor 2 operate. After that, the high-temperature gas-cooled reactor 1 and the serial gas-cooled reactor 2 can operate at the same time or not at the same time.

Alternatively, when the high-temperature gas-cooled reactor 1 does not produce enough first spent fuel for the core of the serial gas-cooled reactor 2 to be loaded, the core of the serial gas-cooled reactor 2 can also be loaded with natural uranium, for example, serial gas-cooled reactor 2 The core of cold reactor 2 is loaded with ²³⁵U of natural uranium with an enrichment of 0.712%, including one or more of UO₂, UC₂, (U, Th) O₂ and (U, Th) C₂.

Optionally, the reactor core outlet temperature of the high-temperature gas-cooled reactor 1 is 750° C.˜1000° C., and the core outlet temperature of serial gas-cooled reactor 2 is 350° C.˜450° C.

For example, the core outlet temperature of serial gas-cooled reactor 2 is 400° C.

By setting the core outlet temperature of the serial gas-cooled reactor 2 to 350° C. to 450° C., the impact of the reactor's negative reactivity temperature coefficient on the effective reproduction coefficient can be reduced. In addition, the core outlet temperature of the serial gas-cooled reactor 2 is set to 350° C.˜450° C., which can avoid difficult engineering issues arising on components or equipment such as graphite components and metal components in the serial gas-cooled reactor 2, as well as hot gas ducts and steam generator heat transfer tubes, which include risks of high-temperature creep deformation and potential creep rupture.

Optionally, the cooling gas pressure of the high-temperature gas-cooled reactor 1 is 3.0 MPa to 7.0 MPa, and the cooling gas pressure of serial gas-cooled reactor 2 is 2.0 MPa˜4.5 MPa.

The cooling gas pressure of the high-temperature gas-cooled reactor 1 can be understood as the pressure of the cooling gas (such as helium) in the first reaction chamber. The cooling gas pressure of the serial gas-cooled reactor 2 can be understood as the pressure of the cooling gas (such as helium) in the second reaction chamber.

By setting the cooling gas pressure of the serial gas-cooled reactor 2 to 2.0 MPa to 4.5 MPa, the pressure resistance requirement for the pressure vessel of the second reactor pressure vessel 201 can be reduced, thereby reducing the cost of the second reactor pressure vessel 201, and thereby also reducing the serial high-temperature gas-cooled reactor nuclear energy system 100 accordingly.

Optionally, the second reactor pressure vessel 201 is a metal pressure vessel or a concrete pressure vessel.

For example, the second reactor pressure vessel 201 is a prestressed concrete pressure vessel.

The second reactor pressure vessel 201 adopts a concrete pressure vessel, which provides technical flexibility for on-site pouring of the serial gas-cooled reactor 2 in the nuclear power plant. In addition, it can be understood that since the critical size of the serial gas-cooled reactor 2 is larger, the size of the second reactor pressure vessel 201 is also larger. The second reactor pressure vessel 201 is a concrete pressure vessel, which is different from the second reactor pressure vessel. Compared with metal pressure vessels, container 201 can solve the engineering difficulties of long-distance transportation and inland transportation.

Optionally, as shown in FIG. 2, a metal lining 203 is located inside the second reactor pressure vessel 201.

For example, the interior of the second reactor pressure vessel 201 is provided with a steel lining. For example, multiple steel plates are welded together on site to form a steel lining, and concrete is poured on the outside of the steel lining 203.

By providing the metal lining 203 inside the second reactor pressure vessel 201, the waterproof properties of the second reactor pressure vessel 201 can be effectively improved.

Optionally, the second reactor pressure vessel 201 further includes a cylindrical graphite reflective layer 202 and a thermal insulation layer 204. The thermal insulation layer 204 is located between the cylindrical graphite reflective layer 202 and the second reactor pressure vessel 201.

For example, the thermal insulation layer 204 is formed by stacking multiple graphite bricks.

By providing the thermal insulation layer 204 between the cylindrical graphite reflective layer 202 and the second reactor pressure vessel 201, on the one hand, the temperature of the second reactor pressure vessel 201 can be effectively reduced, which is beneficial to improving the safety of the serial gas-cooled reactor 2; On the other hand, the heat transferred from the cylindrical graphite reflective layer 202 to the second reactor pressure vessel 201 can be effectively reduced, allowing more heat of the serial gas-cooled reactor 2 to be utilized, which is beneficial to improving the thermal efficiency of the serial gas-cooled reactor 2. This is beneficial to further improving the thermal efficiency of the serial high-temperature gas-cooled reactor nuclear energy system 100.

Optionally, as shown in FIG. 2, a columnar graphite reflective layer 205 in which the reactor control rod 206 is inserted is provided in the middle of the cylindrical graphite reflective layer 202. An annular space is defined between the columnar graphite reflective layer 205 and the cylindrical graphite reflective layer 202, which is used to accommodate the first spent fuel.

Therefore, it is convenient to add the reactor control rod 206 in the second reaction chamber, which is beneficial to increasing the reactivity control capability of the serial gas-cooled reactor 2.

In other embodiments, the reactor control rods may not be provided in the middle of the cylindrical graphite reflective layer 202. For example, the columnar graphite reflective layer provided in the middle of the cylindrical graphite reflective layer 202 does not have a space for the reactor control rods to be inserted. channel, which is conducive to improving the structural strength of the reaction chamber and the reactor neutron economy of the serial gas-cooled reactor 2.

Specifically, compared with the structure of the second reaction chamber of the serial gas-cooled reactor 2 and the reaction chamber of the high-temperature gas-cooled reactor in the prior art, the only difference is that the pressure vessel of the high-temperature gas-cooled reactor in the prior art is a metal pressure vessel, and the pressure vessel of the second reaction chamber is a concrete pressure vessel with a metal lining inside. Of course, the structure of the second reaction chamber of the serial gas-cooled reactor 2 and the reaction chamber of the high-temperature gas-cooled reactor in the prior art can also be the same.

Optionally, the serial high-temperature gas-cooled reactor nuclear energy system 100 also includes a plurality of first steam generators 9. The plurality of first steam generators 9 correspond to the plurality of high-temperature gas-cooled reactors 1 one-to-one. Each first steam generator 9 Generator 9 is connected to the corresponding high-temperature gas-cooled reactor 1.

For example, as shown in FIG. 1, the number of first steam generators 9 is two. The two first steam generators 9 correspond to the two high-temperature gas-cooled reactors 1 one-to-one. Each first steam generator 9 corresponds to a corresponding high-temperature gas-cooled reactor 1, the two of which are connected through the first cooling air duct. Specifically, the first cooling air conduit includes a first inner tube and a first outer tube 1013. The first outer tube 1013 is sleeved on the outside of the first inner tube, so that the inside of the first inner tube forms a first internal channel. An annular first external channel is formed between the inner tube and the first outer tube. The first steam generator 9 has a first liquid inlet 901 and a first steam outlet 902. Wherein, both ends of the first internal channel are connected to the first reaction chamber and the first steam generator 9 respectively, and both ends of the first external channel are connected to the first reaction chamber and the first steam generator 9 respectively. The first liquid inlet 901 is for liquid water to enter, and the first steam outlet 902 is for steam to flow out.

When the high-temperature gas-cooled reactor 1 is specifically operating, cold cooling gas (such as helium) enters the first reaction chamber of the high-temperature gas-cooled reactor 1 through the first external channel, and is heated by the heat released by the high-temperature gas-cooled reactor 1 into hot cooling gas. gas; the hot cooling gas enters the first steam generator 9 through the first internal channel, and the liquid water enters the first steam generator 9 through the first liquid inlet 901, and the hot cooling gas is used to cool the interior of the first steam generator 9 The liquid water is heated to obtain steam and cold cooling gas; then, the steam flows out of the first steam generator 9 through the first steam outlet 902, and the cold cooling gas enters the first part of the high-temperature gas-cooled stack 1 through the first external channel. In the reaction chamber, the above processes are repeated in cycles.

Among them, as shown in FIG. 1, the serial high-temperature gas-cooled reactor nuclear energy system 100 also includes a first main helium fan 903. The first main helium fan 903 is used to provide flow power for the cooling gas in the first reaction chamber.

In some embodiments, the serial high-temperature gas-cooled reactor nuclear energy system 100 further includes a second steam generator 10, and the second steam generator 10 is connected to the serial gas-cooled reactor 2.

For example, as shown in FIG. 2, the second steam generator 10 is connected to the serial gas-cooled stack 2 through a second cooling air conduit. Specifically, the second cooling air conduit includes a second inner tube 2014 and a second outer tube 2013. The second outer tube 2013 is sleeved on the outside of the second inner tube 2014, so that the inside of the second inner tube 2014 forms a second internal channel, and an annular second external channel is formed between the second inner tube 2014 and the second outer tube 2013. The second steam generator 10 has a second liquid inlet 1001 and a second steam outlet 1002. Wherein, both ends of the second internal channel are connected to the second reaction chamber and the second steam generator 10 respectively, and both ends of the second external channel are connected to the second reaction chamber and the second steam generator 10 respectively. The second liquid inlet 1001 is for liquid water to enter, and the second steam outlet 1002 is for steam to flow out.

When the serial gas-cooled reactor 2 is specifically operating, as shown by the arrow in FIG. 2, cold cooling gas (such as helium) enters the second reaction chamber of the serial gas-cooled reactor 2 through the second external channel and is serially The heat released by the gas-cooled stack 2 is heated into hot cooling gas; the hot cooling gas enters the second steam generator 10 through the second internal channel, and the liquid water enters the second steam generator 10 through the second liquid inlet 1001, using this The hot cooling gas heats the liquid water in the second steam generator 10 to obtain steam and cold cooling gas; then, the steam flows out of the second steam generator 10 through the second steam outlet 1002, and the cold cooling gas passes through The second external channel enters the second reaction chamber of the serial gas-cooled reactor 2, and the above processes are repeated in cycles.

Among them, the serial high-temperature gas-cooled reactor nuclear energy system 100 also includes a second main helium fan 1003. The second main helium fan 1003 is used to provide flow power for the cooling gas in the second reaction chamber.

In other embodiments, the serial high-temperature gas-cooled reactor nuclear energy system 100 further includes an intermediate heat exchanger, and the intermediate heat exchanger is connected to the serial gas-cooled reactor 2.

More specifically, the intermediate heat exchanger is a gas-gas heat exchanger.

For example, the intermediate heat exchanger is connected to the serial gas-cooled stack 2 through a second cooling air duct. Specifically, the second cooling air conduit includes a second inner tube and a second outer tube. The second outer tube is sleeved on the outside of the second inner tube, so that the inside of the second inner tube forms a second internal channel. An annular second outer channel is formed between the second inner tube and the second outer tube. The intermediate heat exchanger has a first cold air inlet and a second cold air outlet. Wherein, both ends of the second internal channel are connected to the second reaction chamber and the intermediate heat exchanger respectively, and both ends of the second external channel are connected to the second reaction chamber and the intermediate heat exchanger respectively. The first cold air inlet supplies the gas to be heated, and the second cold air outlet is for the heated gas to flow out.

When the serial gas-cooled reactor 2 is specifically operating, cold cooling gas (such as helium) enters the second reaction chamber of the serial gas-cooled reactor 2 through the second external channel, and is heated by the heat released by the serial gas-cooled reactor 2. Hot cooling gas; the hot cooling gas enters the intermediate heat exchanger through the second internal channel, the gas to be heated enters the intermediate heat exchanger through the first cold air inlet, and the hot cooling gas is used to heat the gas in the intermediate heat exchanger. The gas is heated to obtain heated gas and cold cooling gas; then, the heated gas flows out of the intermediate heat exchanger through the second cold air outlet, and the cold cooling gas enters the serial gas-cooled stack 2 through the second external channel. The above processes are repeated in cycles.

Optionally, the fuel core of the first fuel element is at least one of UO₂, UC₂, ThO₂, ThC₂, (U, Th)O₂ and (U, Th)C₂.

The above can be understood as: the fuel core is UO₂, UC₂, ThO₂, ThC₂, (U, Th)O₂ and (U, Th)C₂.

In some embodiments, the serial high-temperature gas-cooled reactor nuclear energy system 100 further includes a first fuel loading/unloading system capable of transferring the first spent fuel in the first reaction chamber to the second reaction chamber.

By setting up the first fuel loading/unloading system, it is convenient to transfer the first spent fuel in the first reaction chamber to the second reaction chamber.

In some embodiments, the high-temperature gas-cooled reactor is a pebble-bed high-temperature gas-cooled reactor, and the first fuel element is a spherical fuel element. The first reactor pressure vessel 101 also has a first fuel inlet 1011 and a first fuel outlet 1012 connected to the first reaction chamber. The second reactor pressure vessel 201 also has a second fuel inlet 2011 and a second fuel outlet connected to the second reaction chamber. The fuel outlet 2012 and the second fuel inlet 2011 are connected to the first fuel outlet 1012 through the first fuel loading/unloading system to transfer the first spent fuel in the first reaction chamber to the second reaction chamber.

By setting the high-temperature gas-cooled reactor as a pebble-bed type high-temperature gas-cooled reactor and the first fuel element as a spherical fuel element, it is further convenient to transfer the first spent fuel in the first reaction chamber to the second reaction chamber.

Optionally, the first fuel loading/unloading system includes a first unloading pipe 3 and a first unloading device 4. One end of the first unloading pipe 3 is connected to the first fuel outlet 1012 through the first unloading device 4 to connect the first fuel outlet 1012 to the first unloading pipe 3. The first spent fuel in a reaction chamber is discharged. The other end of the first unloading pipe 3 is connected to the second fuel inlet 2011 to load the first spent fuel unloaded from the first reaction chamber into the second reaction chamber.

Optionally, second fuel inlet 2011 is positioned lower than first fuel outlet 1012.

The second fuel inlet 2011 is positioned lower than the first fuel outlet 1012, so that the first spent fuel can flow from the first fuel outlet 1012 to the second fuel inlet 2011 by its own weight along the first unloading pipe 3 from the first unloading device 4. It is beneficial to further reduce the operating cost of the serial high-temperature gas-cooled reactor nuclear energy system 100.

Optionally, the serial high-temperature gas-cooled reactor nuclear energy system 100 also includes a fuel circulation pipe. One end of the fuel circulation pipe is connected to the first fuel outlet 1012 through the first unloading device 4, and the other end of the fuel circulation pipe is connected to the first fuel outlet. Inlet 1011 is connected so that the first fuel element circulates in the first reaction chamber.

By arranging the fuel circulation pipe, the spherical fuel element in the first reaction chamber can undergo a specified number of “core unloading-loading into the reactor” fuel circulation, which is beneficial to improving the discharge burnup of the first fuel element in the high-temperature gas-cooled reactor 1, hence further improving the utilization rate of nuclear fuel.

It should be noted that the number of cycles of the first fuel element in the first reaction chamber is determined according to the design of the high-temperature gas-cooled reactor 1 until the first fuel element reaches the unloading fuel consumption.

Preferably, the number of cycles of the first fuel element in the first reaction chamber 1 is 6 to 15.

Specifically, the serial high-temperature gas-cooled reactor nuclear energy system 100 includes a fuel circulation system 5. The fuel circulation system 5 includes the above-mentioned fuel circulation pipe, and the fuel circulation pipe is connected to the first unloading pipe 3. The flow of the first fuel element in the fuel circulation pipe and the first unloading pipe 3 is achieved by introducing cooling gas (for example, helium gas) into the fuel circulation pipe and the first unloading pipe 3. Among them, a first radiation measuring device for detecting the burnup of the first fuel element is disposed in the first unloading pipe 3. After the first fuel element is unloaded from the first reaction chamber through the first unloading device 4, the first radiation measurement device is used to detect the burnup of the unloaded first fuel element. When the unloaded first fuel element reaches the unloading During the burn-up period, the first fuel element serves as the first spent fuel and enters the second reaction chamber through the first unloading pipe 3; when the discharged first fuel element does not reach the unloading burn-up period, the first fuel element passes through the fuel The circulation tube returns to the first reaction chamber.

In other embodiments, the high-temperature gas-cooled reactor is a prismatic high-temperature gas-cooled reactor, and the first fuel element is a prismatic fuel element. The first reactor pressure vessel 101 is provided with a first inlet and outlet and a first reactor pressure vessel top cover for defining the first reaction chamber, and the first inlet and outlet is connected with the first reaction chamber. The second reactor pressure vessel 201 is provided with a second inlet and outlet and a second reactor pressure vessel top cover 207 for defining the second reaction chamber. The second inlet and outlet are connected with the second reaction chamber. The first fuel loading/unloading system can unload the first spent fuel in the first reaction chamber through the first inlet and outlet, and load it into the second reaction chamber through the second inlet and outlet.

For example, the first fuel loading/unloading system includes a first hoisting device, which grabs the prismatic fuel elements from the first reaction chamber through the first inlet and outlet, and places the grabbed prismatic fuel elements into the second reaction chamber.

Optionally, the second inlet and outlet are positioned on the same level with the first inlet and outlet.

The second inlet and outlet are positioned on the same level with the first inlet and outlet. Compared with the second inlet and outlet which is higher than the first inlet and outlet, it is convenient to transfer the first spent fuel in the first reaction chamber to the second reaction chamber through the first fuel loading/unloading system. Inside

Optionally, the second inlet and outlet are lower than the first fuel outlet 1012.

The second inlet and outlet are positioned lower than the first inlet and outlet. Compared with the second inlet and outlet which is higher than the first inlet and outlet, it is convenient to transfer the first spent fuel in the first reaction chamber to the second reaction chamber through the first fuel loading/unloading system.

The second inlet and outlet are positioned lower than the first inlet and outlet. Compared with the second inlet and outlet which is higher than the first inlet and outlet, it is convenient to transfer the first spent fuel in the first reaction chamber to the second reaction chamber through the first fuel loading/unloading system.

In some embodiments, the serial high-temperature gas-cooled reactor nuclear energy system 100 also includes a spent fuel storage tank 6. The spent fuel storage tank 6 has a storage chamber 601, and the storage chamber 601 is connected to the second reaction chamber to facilitate the entrance of the second spent fuel into the second reaction chamber 601.

After the first spent fuel reaches the discharge burnup in the second reaction chamber, it becomes the second spent fuel. The second spent fuel is unloaded from the second reaction chamber and then transported to the spent fuel storage tank 6 for storage, which facilitates the subsequent processing of the second spent fuel.

Optionally, the serial high-temperature gas-cooled reactor nuclear energy system 100 also includes a second fuel loading/unloading system, which is used to transfer the second spent fuel in the second reaction chamber to the storage chamber 601.

By setting up the second fuel loading/unloading system, it is convenient to transfer the second spent fuel in the second reaction chamber to the storage chamber 601.

In some embodiments, the high-temperature gas-cooled reactor is a pebble-bed high-temperature gas-cooled reactor, and the first fuel element is a spherical fuel element. The spent fuel storage tank 6 has a spent fuel inlet 6011, wherein the second fuel inlet 2011 is connected to the first fuel outlet 1012, and the spent fuel inlet 6011 is connected to the second fuel inlet 2011 through the second fuel loading/unloading system to facilitate transfer of the second spent fuel from the second reaction chamber to the storage chamber 601.

By setting the high-temperature gas-cooled reactor 1 as a pebble-bed high-temperature gas-cooled reactor and the first fuel element as a spherical fuel element, it is further convenient to transfer the second spent fuel in the second reaction chamber to the storage chamber 601.

Optionally, the second fuel loading/unloading system includes a second unloading pipe 7 and a second unloading device 8. One end of the second unloading pipe 7 is connected to the second fuel outlet 2012 through the second unloading device 8 to connect the second fuel outlet 2012 to the second unloading pipe 7. The second spent fuel in the second reaction chamber is unloaded, and the other end of the second unloading pipe 7 is connected to the spent fuel inlet 6011 to load the second spent fuel unloaded from the second reaction chamber into the storage chamber 601.

Optionally, spent fuel inlet 6011 is positioned lower than second fuel outlet 2012.

The spent fuel inlet 6011 is positioned lower than the second fuel outlet 2012, so that the second spent fuel can flow from the second unloading device 8 along the second unloading pipe 7 by its own weight from the second fuel outlet 2012 into the spent fuel inlet 6011, which is beneficial by further reducing operating costs of serial high-temperature gas-cooled reactor nuclear energy systems 100.

Optionally, the serial high-temperature gas-cooled reactor nuclear energy system 100 also includes a spent fuel circulation pipe. One end of the spent fuel circulation pipe is connected to the second fuel outlet 2012 through the second unloading device 8, and the other end of the spent fuel circulation pipe is connected to the second fuel inlet 2011, so that the first spent fuel circulates in the second reaction chamber.

By setting up a spent fuel circulation pipe, the spherical first spent fuel in the second reaction chamber can undergo a specified number of “core unloading-loading into the reactor” fuel cycles, which is beneficial to improving the discharge burnup of the nuclear fuel in serial air-cooling reactor 2, thereby further improving the utilization rate of nuclear fuel.

It should be noted that the number of cycles of the first spent fuel in the second reaction chamber is determined according to the design of the serial gas-cooled reactor 2 until the first spent fuel reaches the unloading fuel consumption.

Specifically, the serial high-temperature gas-cooled reactor nuclear energy system 100 includes a spent fuel circulation system (not shown in the figures). The spent fuel circulation system includes the above-mentioned spent fuel circulation pipe, and the spent fuel circulation pipe is connected to the second unloading pipe 7. The flow of the first spent fuel in the spent fuel circulation pipe and the second unloading pipe 7 is achieved by introducing cooling gas (for example, helium gas) into the spent fuel circulation pipe and the second unloading pipe 7. Among them, a second radiation measuring device for detecting the burnup of the first spent fuel is provided in the second unloading pipe 7. After the first spent fuel is unloaded from the second reaction chamber through the second unloading device 8, the second radiation measuring device is used to detect the burnup of the unloaded first spent fuel. When the unloaded first spent fuel reaches discharge burnup, the first spent fuel turns into the second spent fuel and enters the storage chamber 601 through the second unloading pipe 7; when the discharged first spent fuel does not reach the unloading burn-up period, the first spent fuel returns to the seconding reaction chamber through the spent fuel circulation tube.

In other embodiments, the high-temperature gas-cooled reactor 1 is a prismatic high-temperature gas-cooled reactor, and the first fuel element is a prismatic fuel element. The spent fuel storage tank 6 has a spent fuel inlet 6011. Wherein, the first fuel loading/unloading system can unload the first spent fuel in the first reaction chamber through the first inlet and outlet, and load it into the second reaction chamber through the second inlet and outlet. The second fuel loading/unloading system is used to transfer the second spent fuel in the second reaction chamber to the storage chamber 601.

For example, the second fuel loading/unloading system includes a second hoisting device that grabs the first spent fuel from the second reaction chamber through the second inlet and outlet, and puts the grabbed first spent fuel into the storage chamber 601.

Optionally, the spent fuel inlet 6011 is positioned on the same level with the second inlet and outlet.

The spent fuel inlet 6011 is positioned on the same level with the second inlet and outlet. Compared with the spent fuel inlet 6011 which is higher than the second inlet and outlet, it is convenient to transfer the second spent fuel in the second reaction chamber to the storage chamber 601 through the second fuel loading/unloading system.

Optionally, spent fuel import 6011 is positioned lower than the second import and export.

The spent fuel inlet 6011 is positioned lower than the second inlet and outlet. Compared with the spent fuel inlet 6011 being higher than the second inlet and outlet, it is convenient to transfer the second spent fuel in the second reaction chamber to the storage chamber 601 through the second fuel loading/unloading system.

Optionally, the plurality of high-temperature gas-cooled reactors 1 and serial gas-cooled reactors 2 are located in the same reactor building, thereby facilitating the connection between high-temperature gas-cooled reactors 1 and serial gas-cooled reactors 2.

The operation method of the serial high-temperature gas-cooled reactor nuclear energy system 100 according to the embodiment of the present invention includes the following steps: adding first fuel elements into the first reaction chambers of multiple high-temperature gas-cooled reactors 1, and operating the high-temperature gas-cooled reactors 1, so that the first fuel element undergoes a nuclear reaction and obtains the first spent fuel. All or part of the first spent fuel produced by multiple high-temperature gas-cooled reactors 1 is added into the second reaction chamber of the serial gas-cooled reactor 2, and the serial gas-cooled reactor 2 is operated so that the first spent fuel undergoes a nuclear reaction.

As a result, the spent fuel discharged from the high-temperature gas-cooled reactor, that is, the first spent fuel, can be directly used as fuel for the serial gas-cooled reactor 2, thereby improving the utilization rate of the first fuel element and reducing the cost of the serial high-temperature gas reactor. The fuel cost of the cold reactor nuclear energy system. In addition, when the high-temperature gas-cooled reactor 1 and the serial gas-cooled reactor 2 operate at the same time, the thermal power of the gas-cooled reactor nuclear energy system can also be increased, which is conducive to the promotion and industrialized application of high-temperature gas-cooled reactors.

Optionally, when the serial high-temperature gas-cooled reactor nuclear energy system 100 is first operated, the high-temperature gas-cooled reactor 1 can be operated first, and when the first spent fuel produced by the high-temperature gas-cooled reactor 1 is enough to be used as fuel for the serial gas-cooled reactor 2, add the first spent fuel into the serial gas-cooled reactor 2, and the serial gas-cooled reactor 2 operates. After that, the high-temperature gas-cooled reactor 1 and the serial gas-cooled reactor 2 can operate at the same time or not at the same time.

Optionally, when the high-temperature gas-cooled reactor 1 does not produce the first spent fuel, natural uranium is added as the second fuel element into the second reaction chamber of the serial gas-cooled reactor 2, and the serial gas-cooled reactor 2 operates so that the second fuel element undergoes a nuclear reaction. Thus, the high-temperature gas-cooled reactor 1 and the serial gas-cooled reactor 2 can be operated simultaneously to improve the thermal efficiency of the serial high-temperature gas-cooled reactor nuclear energy system 100.

In some embodiments, the plurality of the high-temperature gas-cooled reactors 1 operate simultaneously.

The simultaneous operation of the plurality of the high-temperature gas-cooled reactors 1 can be understood as synchronized operation of multiple high-temperature gas-cooled reactors 1. For example, the plurality of the high-temperature gas-cooled reactors perform loading, dumping, and unloading operations at the same time.

In other embodiments, multiple high-temperature gas-cooled reactors 1 operate at preset intervals.

Research shows that when the serial high-temperature gas-cooled reactor nuclear energy system 100 includes 2 to 3 high-temperature gas-cooled reactors 1, the reactor thermal power of the serial gas-cooled reactor 2 can reach the reactor thermal power of the 2 to 3 high-temperature gas-cooled reactors located upstream. 70% to 80% of the total reactor thermal power of the cold reactor 1. Compared with the serial high-temperature gas-cooled reactor nuclear energy system in the existing technology, which only includes high-temperature gas-cooled reactors, the thermal power of the serial high-temperature gas-cooled reactor nuclear energy system 100 has been greatly improved.

The serial high-temperature gas-cooled reactor nuclear energy system 100 according to the embodiment of the present invention has the following advantages:
(i) By utilizing the spent fuel (first spent fuel) currently used as nuclear waste in high-temperature gas-cooled reactors and loading it into the serial gas-cooled reactor 2 as fuel to generate nuclear energy, not only can the nuclear waste be utilized, but also the thermal power output of nuclear power plant reactors can be increased. The problem that the current technical level of high-temperature gas-cooled reactors around the world do not have the technical and economic advantages to compete with large commercial reactors, such as pressurized water reactors, heavy water reactors and boiling water reactors can thus be solved;
(ii) The serial gas-cooled reactor 2 can use steel-lined concrete or prestressed concrete pressure vessels, so that the on-site casting of the pressure vessels of the serial gas-cooled reactor 2 is possible, which solves the problem of transportation or inland transfer of large-volume reactor pressure vessels.;
(iii) The serial gas-cooled reactor 2 can “burn” the fission plutonium in the spent fuel of the high-temperature gas-cooled reactor upstream of its fuel cycle. Therefore, the serial high-temperature gas-cooled reactor nuclear energy system 100 has a fourth-generation advanced nuclear energy system to prevent nuclear proliferation (the plutonium in the spent fuel has a lower proportion of ²³⁹Pu and higher proportion of ²⁴⁰Pu content), and the serial gas-cooled reactor 2 also has the inherent safety of high-temperature gas-cooled reactors;
(iv) The reactor thermal power of serial gas-cooled reactor 2 is 70% to 80% of the sum of the reactor thermal power of the plurality of high-temperature gas-cooled reactors upstream. The economic benefits are huge, and the unique technology of the advanced nuclear energy system of serial gas-cooled reactor 2 can guarantee safe, reliable and economical operation of high-temperature gas-cooled reactors promotes the industrialized application of high-temperature gas-cooled reactors.

In the description of the present invention, it should be understood that the terms “center”, “longitudinal”, “transverse”, “length”, “ width” , “thickness”, “upper”, “lower”, “front”, “back”, “left”, “right”, “vertical”, “horizontal”, “top”, “bottom”, “inside”, “outside”, “clockwise”, “counterclockwise”, “axis”, “radial direction”, “circumferential direction”, etc. , which indicate orientations or positional relationships, are based on the orientations or positional relationships shown in the drawings. They are only for the convenience of describing the present invention and simplifying the description, and do not indicate or imply that the referred devices or components must have a specific orientation, be constructed and operate in a specific orientation and are therefore not to be construed as limitations of the invention.

In addition, the terms “first” and “second” are used for descriptive purposes only and cannot be understood as indicating or implying relative importance or implicitly indicating the quantity of indicated technical features. Therefore, features defined as “first” and “second” may explicitly or implicitly include at least one of these features. In the description of the present invention, “plurality” means at least two, such as two, three, etc., unless otherwise clearly and specifically limited.

In the present invention, unless otherwise clearly stated and limited, the terms “installation”, “connection”, “connection”, “fixing” and other terms should be understood in a broad sense. For example, it can be a fixed connection or a detachable connection, or integrated; it can be mechanically connected, electrically connected or communicable with each other; it can be directly connected or indirectly connected through an intermediate medium; it can be the internal connection of two elements or the interaction between two elements, unless otherwise expressly limited. For those of ordinary skill in the art, the specific meanings of the above terms in the present invention can be understood according to specific circumstances.

In the present invention, unless otherwise expressly stated and limited, a first feature being “on” or “below” a second feature may mean that the first and second features are in direct contact, or the first and second features are in indirect contact through an intermediate medium. touch. Furthermore, the terms “above” or “on top of” the first feature is above the second feature may mean that the first feature is vertically above or diagonally above the second feature, or simply means that the first feature is higher in level than the second feature. “Under”, “below” and “beneath” the first feature of the second feature may mean that the first feature is vertically below or diagonally below the second feature, or simply means that the first feature has a smaller horizontal height than the second feature.

In the present disclosure, the terms “one embodiment”, “some embodiments”, “example”, “specific examples”, or “some examples” etc. mean the specific features, structures, materials or materials described in connection with the embodiment or example. Features are included in at least one embodiment or example of the invention. In this specification, the schematic expressions of the above terms are not necessarily directed to the same embodiment or example. Furthermore, the specific features, structures, materials or characteristics described may be combined in any suitable manner in any one or more embodiments or examples. Furthermore, those skilled in the art may combine and combine the different embodiments or examples and the features of different embodiments or examples described in this specification unless they are inconsistent with each other.

Although the embodiments of the present invention have been shown and described above, it can be understood that the above-mentioned embodiments are illustrative and should not be construed as limitations of the present invention. Changes, modifications, and replacements and modifications to the above-described embodiments may be made by those of ordinary skill in the art, and are within the scope of the present invention.

1. A serial high-temperature gas-cooled reactor nuclear energy system (100), comprising:
a plurality of high-temperature gas-cooled reactors (1), wherein the high-temperature gas-cooled reactor (1) includes a first reactor pressure vessel (101) having a first reaction chamber for receiving the first fuel element; and
a serial gas-cooled reactor (2), wherein the serial gas-cooled reactor (2) includes a second reactor pressure vessel (201), the second reactor pressure vessel (201) having a second reaction chambers wherein the first reaction chambers of the plurality of high-temperature gas-cooled reactor (1) are all connected to the second reaction chambers, allowing the first spent fuel in the first reaction chambers to enter the second reaction chambers.

2. The serial high-temperature gas-cooled reactor nuclear energy system (100) of claim 1, further comprising a first fuel loading/unloading system, wherein the first fuel loading/unloading system is capable of transferring all the first spent fuel in the first reaction chamber to the second reaction chamber.

3. The serial high-temperature gas-cooled reactor nuclear energy system (100) of claim 2, wherein:
the high-temperature gas-cooled reactor (1) is a pebble-bed high-temperature gas-cooled reactor, and the first fuel elements are spherical fuel elements;
the first reactor pressure vessel (101) further includes a first fuel inlet (1011) and a first fuel outlet (1012) connected with the first reaction chamber;
the second reactor pressure vessel (201) further includes a second fuel inlet (2011) and a second fuel outlet (2012) connected with the second reaction chamber; and
the first fuel outlet (1012) and the second fuel inlet (2011) are connected through the first fuel loading/unloading system to transfer the first spent fuel in the first reaction chamber to the second reaction chamber.

4. The serial high-temperature gas-cooled reactor nuclear energy system (100) of claim 3, wherein the first fuel loading/unloading system includes a first unloading pipe (3) and a first unloading device (4), wherein one end of the first unloading pipe (3) is connected to the first fuel outlet (1012) through the first unloading device (4), and wherein the other end of the first unloading pipe (3) is connected to the second fuel inlet (2011) to transfer the first spent fuel unloaded from the first reaction chamber to the second reaction chamber.

5. The serial high-temperature gas-cooled reactor nuclear energy system (100) of claim 4, wherein the second fuel inlet (2011) is positioned lower than the first fuel outlet (1012).

6. The serial high-temperature gas-cooled reactor nuclear energy system (100) of claim 2, wherein:
the high-temperature gas-cooled reactor (1) is a prismatic high-temperature gas-cooled reactor, and the first fuel elements are prismatic fuel elements;
the first reactor pressure vessel (101) further comprises a first inlet and outlet located on the first reaction chamber, and a first reactor pressure vessel top cover for confining the first reaction chamber, wherein the first inlet and outlet are connected with the first reaction chamber; and
the second reactor pressure vessel (201) further comprises a second intel and outlet located on the second reaction chamber, and a second reactor pressure vessel top cover (207) used to define the second reaction chamber; wherein the second inlet and outlet are connected to the second reaction chamber; such that the first spent fuel is unloaded by the first fuel loading/unloading system in the first reaction chamber through the first passage, and loaded into the second reaction chamber through the second inlet and outlet.

7. The serial high-temperature gas-cooled reactor nuclear energy system (100) of claim 6, wherein the second inlet and outlet are positioned on the same level or lower than the first inlet and outlet.

8. The serial high-temperature gas-cooled reactor nuclear energy system (100) of claim 1, further including a spent fuel storage tank (6), wherein the spent fuel storage tank (6) comprises a storage chamber (601) connected with the second reaction chamber to allow transfer of the second spent fuel from the second reaction chamber to the storage chamber (601).

9. The serial high-temperature gas-cooled reactor nuclear energy system (100) of claim 8, further comprising a second fuel loading/unloading system for the transfer of the second spent fuel from the second reaction chamber to the storage chamber (601).

10. The serial high-temperature gas-cooled reactor nuclear energy system (100) of claim 9, wherein:
the high-temperature gas-cooled reactor is a pebble-bed high-temperature gas-cooled reactor, and the first fuel element is a spherical fuel element;
the first reactor pressure vessel (101) further including a first fuel inlet (1011) and a first fuel outlet (1012) connected with the first reaction chamber;
the second reactor pressure vessel (201) further including second fuel inlet (2011) and the second fuel outlet (2012) connected to the second reaction chamber; and
the spent fuel storage tank (6) includes a spent fuel inlet (6011) connected to the storage chamber (601);
wherein the second fuel inlet (2011) is connected to the first fuel outlet (1012), and the second fuel inlet (2011) is connected to the spent fuel inlet (6011) through the second fuel loading/unloading system.

11. The serial high-temperature gas-cooled reactor nuclear energy system (100) of claim 10, wherein the second fuel loading/unloading system includes:
a second unloading pipe (7); and
a second unloading device (8);
wherein one end of the second unloading pipe (7) is connected to the second fuel outlet (2012) through the second unloading device (8) to connect the second unloading pipe (7) to the second fuel outlet (2012) for unloading the second spent fuel from the second reaction; and
wherein the other end of the second unloading pipe (7) is connected to the spent fuel inlet (6011) to load all the second spent fuel from the second reaction chamber into the storage chamber (601).

12. The serial high-temperature gas-cooled reactor nuclear energy system (100) of claim 11, wherein the spent fuel inlet (6011) is positioned lower than the second fuel outlet (2012).

13. The serial high-temperature gas-cooled reactor nuclear energy system (100) of claim 11, wherein the second fuel loading/unloading system further includes a spent fuel circulation pipe, wherein one end of the spent fuel circulation pipe passes through the second unloading device (8) and connects to the second fuel outlet (2012), and wherein the other end of the spent fuel circulation pipe is connected to the second fuel inlet (2011) to allow circulation of the first spent fuel in the second reaction chamber.

14. The serial high-temperature gas-cooled reactor nuclear energy system (100) of claim 10, wherein the high-temperature gas-cooled reactor (1) is a prismatic high-temperature gas-cooled reactor, and the first fuel elements prismatic fuel elements;
wherein the first reactor pressure vessel (101) includes a first inlet and outlet, and a first reactor pressure vessel top cover for confining the first reaction chamber, the first inlet and outlet are connected to the first reaction chamber; and
wherein the second reactor pressure vessel (201) includes a second inlet and outlet and a second reactor pressure vessel top cover (207) used to confine the second reaction chamber, the second inlet and outlet are connected to the second reactor pressure chamber, and the spent fuel storage tank (6) includes a spent fuel inlet (6011) connected with the storage chamber (601);
wherein the second fuel loading/unloading system unloads the second spent fuel from the second reaction chamber through the second inlet and outlet, into the storage chamber (601) through the spent fuel inlet (6011).

15. The serial high-temperature gas-cooled reactor nuclear energy system (100) of claim 14, wherein the spent fuel inlet (6011) is positioned on the same level or lower than the second inlet and outlet.

16. The serial high-temperature gas-cooled reactor nuclear energy system (100) of claim 1, wherein the number of high-temperature gas-cooled reactors (1) is 2 to 3.

17. The serial high-temperature gas-cooled reactor nuclear energy system (100) of claim 1, wherein:
the core outlet temperature of the high-temperature gas-cooled reactor (1) is 750° C. to 1000° C.; and
the core outlet temperature of the serial gas-cooled reactor (2) is 350° C. to 450° C.

18. The serial high-temperature gas-cooled reactor nuclear energy system (100) of claim 1, wherein:
the cooling gas pressure of the high-temperature gas-cooled reactor (1) is 3.0 MPa to 7.0 MPa; and
the cooling gas pressure of the serial gas-cooled reactor (2) is 2.0 MPa to 4.5 MPa.

19. The serial high-temperature gas-cooled reactor nuclear energy system (100) of claim 18, wherein the second reactor pressure vessel (201) is a metal pressure vessel or a concrete pressure vessel.

20. The serial high-temperature gas-cooled reactor nuclear energy system (100) of claim 19, further comprising a metal lining (203) inside the concrete pressure vessel.

21. The serial high-temperature gas-cooled reactor nuclear energy system (100) of claim 19, wherein the second reactor pressure vessel (201) further includes:
a cylindrical graphite reflective layer (202) located in the second reaction chamber; and
a thermal insulation layer (204) between the cylindrical graphite reflective layer (202) and the second reactor pressure vessel (201).

22. The serial high-temperature gas-cooled reactor nuclear energy system (100) of claim 21, further comprising a columnar graphite reflector layer (205) for inserting the reactor control rod (206) in the middle of the cylindrical graphite reflective layer (202);
wherein an annular space is confined between the columnar graphite reflective layer (205) and the cylindrical graphite reflective layer (202) for the containment of the first spent fuel.

23. The serial high-temperature gas-cooled reactor nuclear energy system (100) of claim 1, further comprising a plurality of first steam generators (9);
wherein each of the first steam generators (9) correspond to each of the high-temperature gas-cooled reactors (1) individually, and each first steam generator (9) is connected to the corresponding high-temperature gas-cooled reactor (1).

24. The serial high-temperature gas-cooled reactor nuclear energy system (100) of claim 1, further comprising:
a second steam generator (10) connected to the serial gas-cooled reactor (2); or
an intermediate heat exchanger connected to the serial gas-cooled reactor (2).

25. The serial high-temperature gas-cooled reactor nuclear energy system (100) of claim 1, wherein the fuel core of the first fuel element is selected from at least one of UO₂, UC₂, ThO₂, ThC₂, (U, Th) O₂ and (U, Th) C₂.

26. An operation method of a serial high-temperature gas-cooled reactor nuclear energy system (100), wherein the serial high-temperature gas-cooled reactor nuclear energy system (100) is a serial high-temperature gas-cooled reactor nuclear energy system (100) of claim 1, wherein the operation method comprises:
adding first fuel elements into the first reaction chambers of a plurality of the high-temperature gas-cooled reactors (1) and operating the high-temperature gas-cooled reactors (1) to initiate nuclear reactions of the first fuel elements and obtain the first spent fuel; and
adding all or part of the first spent fuel produced by multiple high-temperature gas-cooled reactors (1) into the second reaction chamber of the serial gas-cooled reactor (2) and operating the serial gas-cooled reactor (2) to allow the first spent fuel to undergo nuclear reaction.

27. The operating method of the serial high-temperature gas-cooled reactor nuclear energy system (100) of claim 26, wherein the plurality of high-temperature gas-cooled reactors (1) are operated simultaneously or under preset time intervals.

28. The operating method of the serial high-temperature gas-cooled reactor nuclear energy system (100) of claim 26, wherein:
natural uranium is used as the third spent fuel when the first spent fuel has not been produced by the high-temperature gas-cooled reactor (1); and
natural uranium is added into the second reaction chamber of the serial gas-cooled reactor (2) as the second fuel element and the serial gas-cooled reactor (2) is operated so that the second fuel element undergoes nuclear reaction.
